(19) United States
(12) Patent Application Publication
(10) Pub. No.: US 2026/0174267 A1
(43) Pub. Date: Jun. 25, 2026

(54) Gasket Structure And Moka Coffee Pot

(71) Applicant: Ji Deng, Jingzhou (CN)

(72) Inventor: Ji Deng, Jingzhou (CN)

(21) Appl. No.: 18/991,347

(22) Filed: Dec. 21, 2024

(51) Int. Cl. A47J 31/06; A47J 31/30

(52) U.S. Cl. CPC A47J 31/0684; A47J 31/303

(57) ABSTRACT

A gasket structure and a moka coffee pot are provided. The gasket structure includes an upper pot body, a lower pot body, and an annular body. The annular body includes an outer annular wall, an inner annular wall, and an end surface arranged between the outer annular wall and the inner annular wall. A filter mesh having a sheet structure is arranged at a center of the annular body, an outer wall of the filter mesh is closely attached to the inner annular wall of annular body, and the filter mesh has an annular end facing outward. The filter mesh is placed inside the annular body, the annular end is supported on the end surface, a local protrusion is formed by protruding outward along the outer annular wall of the annular body, and the local protrusion is in close contact with an inner wall of the upper pot body.

### TECHNICAL FIELD

The present application relates to the technical field of gaskets, and specifically to a gasket structure and a moka coffee pot comprising the same.

### BACKGROUND

Moka coffee pot is a tool for extracting the base of Italian espresso, which began to become popular in Italian families due to its convenient coffee making operation. With the development of the times, the moka coffee pot gradually developed into a product and now has been marketed to the world.

The moka coffee pot is divided into upper, middle and lower structures, that is, an upper pot body, a middle part, and a lower pot body. The lower pot body is a sink for holding water, the middle part is a powder trough for placing coffee powder, and the upper pot body is used to hold extracted coffee liquid. It principle is to heat the water in the lower pot body into steam, and use the pressure of the steam to push the water up to the siphon and enter the powder trough to extract the coffee liquid, and then the coffee liquid continues to be pushed up through the outlet pipe to the upper pot body for aggregation and outflow.

In existing technologies, a layer of filter mesh is usually covered on the top of the powder trough to filter coffee powder and prevent it from entering the coffee liquid. A gasket is fitted around the filter mesh, which is tightly attached to the inner wall of the upper pot body to seal and prevent steam leakage. FIG. 1 shows a commonly used gasket structure in the existing technologies, which is roughly circular in shape and utilizes a frictional force generated by the contact between the outer wall and the inner wall of the upper pot body to maintain the stability of the tight fit between the two.

However, after using the moka coffee pot, the filter mesh needs to be disassembled and cleaned, as shown in FIG. 2. Due to the gasket being trapped inside the upper pot body and excessive friction with the inner wall, users often have to use tools to penetrate deep into the upper pot body to remove it, which can cause unnecessary trouble in disassembling the filter mesh and easily damage the interior of the upper pot body.

### SUMMARY

In view of above problems, in a first aspect, the present disclosure aims to provide a gasket structure, including an upper pot body, a lower pot body, and an annular body. Herein the annular body includes an outer annular wall, an inner annular wall, and an end surface arranged between the outer annular wall and the inner annular wall. A filter mesh having a sheet structure is arranged at a center of the annular body, an outer wall of the filter mesh is closely attached to the inner annular wall of annular body, and the filter mesh has an annular end facing outward. When the filter mesh is placed inside the annular body and the annular end is supported on the end surface, a local protrusion is formed by protruding outward along the outer annular wall of the annular body, and the local protrusion is in close contact with an inner wall of the upper pot body.

Preferably, a non-contact part is provided on the outer annular wall of the annular body, and the non-contact part is not in contact with the inner wall of the upper pot body when the local protrusion is in close contact with the inner wall of the upper pot body. Furthermore, the non-contact part is obliquely offset along the outer annular wall of the annular body towards the center of the annular body to form a first expansion zone with the inner wall of the upper pot body.

Preferably, a cross-sectional area of the local protrusion accounts for less than one-third of a cross-sectional area of the outer annular wall of the annular body.

Preferably, several curved portions are provided on a side of the local protrusion near the lower pot body, and the curved portions form a second expansion zone between the local protrusion and the inner wall of the upper pot body.

Preferably, the curved portions have a triangular cross-section.

Preferably, the curved portions have a curved cross-section.

Preferably, an extension is arranged along the inner annular wall of the annular body towards the lower pot body.

In a second aspect, the present disclosure further provides a moka coffee pot, including the gasket structure described above.

Preferably, the moka coffee pot further includes a powder trough, the powder trough is placed inside the lower pot body, the filter mesh covers on the powder trough, a siphon is provided at a bottom of the powder trough to communicate with the lower pot body, and an outlet pipe is provided in a middle of the upper pot body to cover on the annular body and a top of the filter mesh.

Compared with the existing technologies, the gasket structure and the moka coffee pot comprising the same of the present disclosure have at least the following beneficial effects and advantages. After the coffee extraction is completed, the annular body will be embedded inside the upper pot body under the action of the friction. There is no need to use tools to remove the annular body from the inside of the upper pot body, just simply tap the upper pot body lightly to naturally remove it, make it easier for the annular body and the filter mesh to detach from the upper pot body for cleaning.

Additional aspects and advantages of the present disclosure will be described below, which will become apparent from the following description or may be learned through practice of the present disclosure.

### BRIEF DESCRIPTION OF THE DRAWINGS

To more clearly describe the technical solutions in the embodiments of the present disclosure or the existing technologies, a brief illustration will be given to the accompanying drawings required for the description of the embodiments or the existing technologies. It is obvious that the accompanying drawings described below are only some embodiments of the present disclosure. For one ordinary skill in the art, other drawings can be obtained based on these drawings without creative labor.

FIG. 1 shows a structural schematic diagram of a gasket having an annular body in the existing technologies.

FIG. 2 shows a structural schematic diagram of a moka coffee pot in the existing technologies.

FIG. 3 shows an overall structure schematic diagram of a gasket structure in accordance with some embodiments of the present disclosure.

FIG. 4 shows a structural schematic diagram of an annular body and a filter mesh of the gasket structure in accordance with some embodiments of the present disclosure.

FIG. 5 shows another structural schematic diagram of the annular body of the gasket structure in accordance with some embodiments of the present disclosure.

FIG. 6 shows a sectional view of the gasket structure in accordance with some embodiments of the present disclosure.

FIG. 7 shows an enlarged partial view of part A in FIG. 6.

FIG. 8 shows still another structural schematic diagram of the annular body of the gasket structure in accordance with some embodiments of the present disclosure.

FIG. 9 shows yet another structural schematic diagram of the annular body of the gasket structure in accordance with some embodiments of the present disclosure.

FIG. 10 shows an overall structure schematic diagram of a moka coffee pot in accordance with some embodiments of the present disclosure.

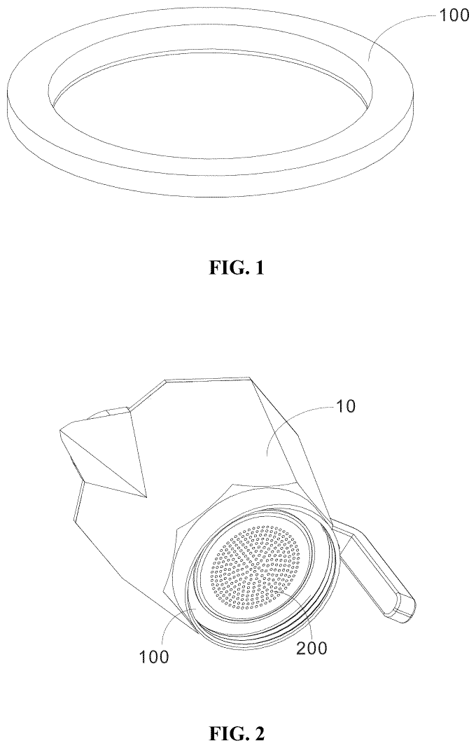

In the drawings, reference signs are as follows. Annular body 100, Outer annular wall 110, Inner annular wall 120, End surface 130, Filter mesh 200, Annular end 220, Upper pot body 10, Lower pot body 20, Local protrusion 211, Non-contact part 212, First expansion zone 213, Curved portion 211a, Second expansion zone 211b, Extension 121, Powder trough 30, Siphon 31, Outlet pipe 11.

### DETAILED DESCRIPTION OF THE EMBODIMENTS

The following will provide a clear and complete description of the technical solutions in the embodiments of the present disclosure. Obviously, the described embodiments are only a part of the embodiments of the present disclosure, and not all of them. Based on the embodiments of the present disclosure, all other embodiments obtained by one of ordinary skill in the art without creative labor shall fall within the scope of protection of the present invention.

The present disclosure will be described in more detail as follows. it should be understood that the specific embodiments described herein are only for explaining the present invention and are not intended to limit the present invention. It should be noted that when a component is described as “fixed to” another component, it may be directly on the other component or there may be one or more centered components in between. When a component is described as “connected” to another component, it may be directly connected to another component, or there may be one or more centered components in between.

In the description of the present disclosure, it should be noted that directional terms such as “front, back, up, down, left, right”, “crosswise, vertical, perpendicular, horizontal”, and “top, bottom” usually indicate directional or positional relationships based on the directional or positional relationships shown in the accompanying drawings. For the convenience of describing the present disclosure and simplifying the description, these directional terms do not indicate or imply that the device or component referred to must have a specific orientation or be constructed and operated in a specific orientation, and therefore cannot be understood as limiting the scope of protection of the present invention, unless otherwise state.

Unless otherwise defined, all technical and scientific terms used in this specification have the same meanings as those commonly understood by those skilled in the art. The terms used in the specification of the present disclosure are only for the purpose of describing the specific embodiments and are not intended to limit the present invention.

In addition, the technical features involved in different embodiments of the present disclosure described below can be combined with each other as long as they do not conflict with each other.

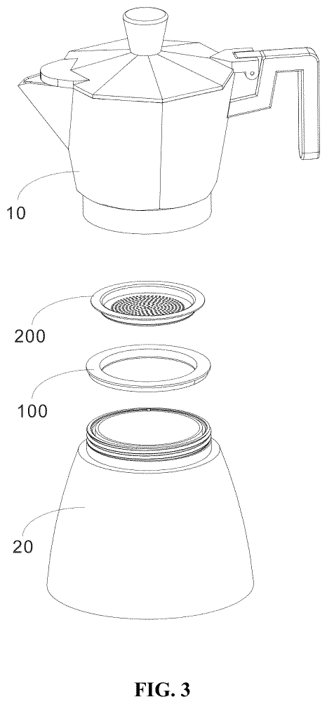

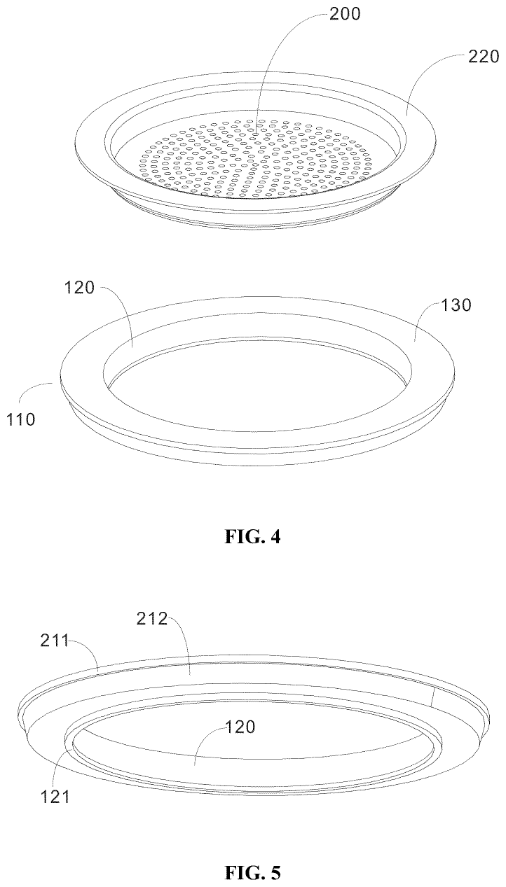

The following will further describe preferred embodiments of the present disclosure in conjunction with the accompanying drawings. As shown in FIG. 3, FIG. 4, and FIG. 5, in some embodiments of the present disclosure, a gasket structure is provided, including an annular body 100. The annular body 100 includes an outer annular wall 110, an inner annular wall 120, and an end surface 130 arranged between the outer annular wall 110 and the inner annular wall 120. A filter mesh 200 having a sheet structure is arranged at a center of the annular body 100, an outer wall of the filter mesh 200 is closely attached to the inner annular wall 120 of the annular body 100, and the filter mesh 200 has an annular end 220 facing outward. When the filter mesh 200 is placed inside the annular body 100, the annular end 220 is supported on the end surface 130 to allow the filter mesh 200 being placed inside the annular body 100. The filter mesh 200 is used to prevent the coffee powder in the lower pot body 20 from entering the upper pot body 10 through the filter mesh 200 during extraction in a moka coffee pot. The outer annular wall 110 of the annular body 100 is in close contact with the inner wall of the upper pot body 10 of the moka coffee pot, providing a sealing effect between the upper pot body 10 and the lower pot body 20 to prevent water vapor of the lower pot body 20 from entering the upper pot body 10. A local protrusion 211 is formed by protruding outward along the outer annular wall 110 of the annular body 100, and the local protrusion 211 is in close contact with the inner wall of the upper pot body 10.

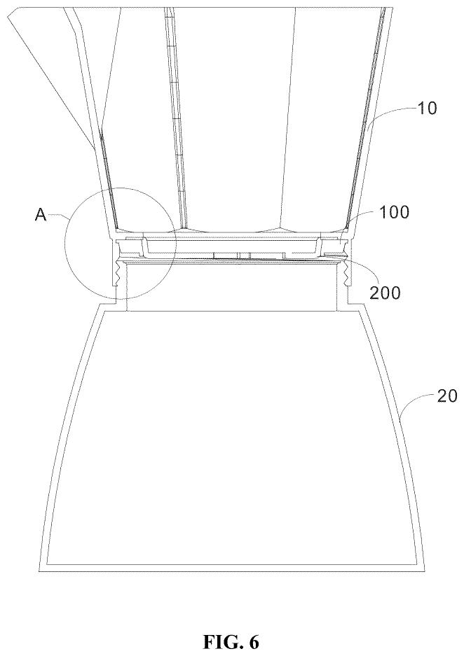

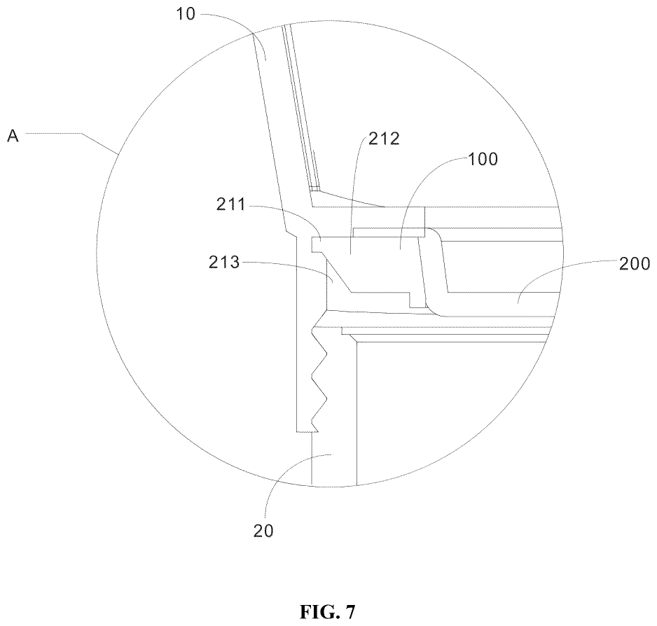

When implementing the gasket structure of the present disclosure, referring to FIG. 6 and FIG. 7, first, place the filter mesh 200 on the inner annular wall 120 of the annular body 100, and use the annular end 220 to support the end surface 130 of the filter mesh 200, so that it is fixed between the filter mesh 200 and the annular body 100. Then, place the filter mesh 200 and the annular body 100 above the lower pot body 20, and then tighten the upper pot body 10 to the top of the lower pot body 20. At this time, the local protrusion 211 of the annular body 100 is in close contact with the inner wall of the upper pot body 10 of the moka coffee pot, thereby preventing water vapor inside the lower pot body 20 from entering into the upper pot body 10. After the coffee extraction is completed, unscrew the upper pot body 10 and the lower pot body 20. Due to the tight contact between the local protrusion 211 and the inner wall of the upper pot body 10 of the moka coffee pot, the annular body 100 will be embedded inside the upper pot body 10 under the action of friction. At this time, vigorously shake the upper pot body 10. Since the local protrusion 211 has a smaller contact surface with the inner wall of the upper pot body 10 compared to the outer annular wall 110, the user can easily shake the annular body 100 out of the upper pot body 10.

Compared to the existing technologies, for the gasket structure of the present disclosure, after the coffee extraction is completed, when the annular body 100 is embedded inside the upper pot body 10 under the action of friction, there is no need to use tools to take out the annular body 100 from the upper pot body 10, just simply shake the upper pot body 10 to eject the annular body 10, making it easier for the annular body 100 and the filter mesh 200 to detach from the upper pot body 10 for cleaning.

When implementing the gasket structure of the present disclosure, further referring to FIG. 5, FIG. 6, and FIG. 7, a non-contact part 212 is provided on the outer annular wall 110 of the annular body 100, and the non-contact part 212 is not in contact with the inner wall of the upper pot body 10 when the local protrusion 211 is in close contact with the inner wall of the upper pot body 10. The non-contact part 212 is obliquely offset along the outer annular wall 110 of the annular body 100 towards the center of the annular body 100 to form a first expansion zone 213 with the inner wall of the upper pot body 10. For the gasket structure of the present disclosure, due to the fact that only the local protrusion 211 is in contact between the annular body 100 and the inner wall of the upper pot body 10, the contact area between the annular body 100 and the upper pot body 10 decreases. The decrease in contact area means that when a large amount of steam evaporates upwards from the lower pot body 20, the annular body 100 and the inner wall of the upper pot body 10 may not be able to maintain close contact under the impact of steam. By setting the non-contact part 212 and forming the first expansion 213 between it and the inner wall of the upper pot body 10, the space for steam to flow upwards is expanded, thereby reducing the impact of steam on the annular body 100. Furthermore, since the non-contact part 212 is obliquely offset towards the center of the annular body 100, a slope will be formed on one side of the first expansion zone 213, which will have a better effect on preventing steam impact.

In some embodiments of the present disclosure, further referring to FIG. 5, FIG. 6, and FIG. 7, a cross-sectional area of the local protrusion 211 accounts for less than one-third of a cross-sectional area of the outer annular wall 110 of the entire annular body 100. After experimentation, this design not only maximizes the stability of the local protrusion 211 and inner wall of the upper pot body 10, but also ensures that the user can easily shake the annular body 100 out of the upper pot body 10 when vigorously shaking the upper pot body 10.

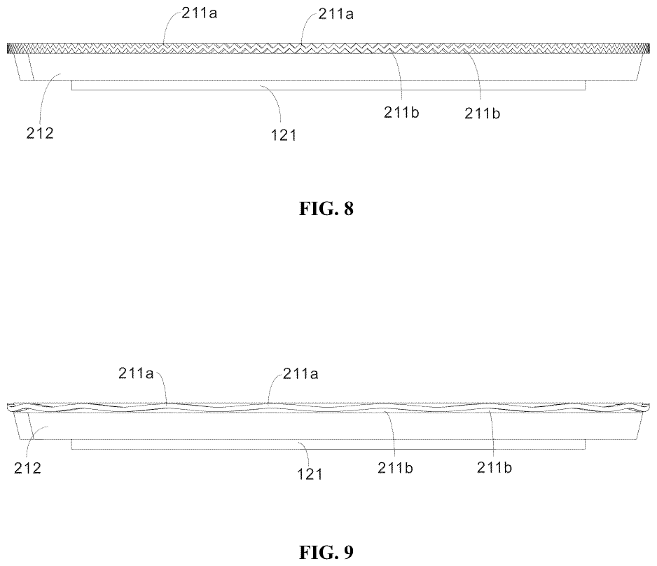

Further referring to FIG. 8 and FIG. 9, several curved portions 211a are provided on a side of the local protrusion 211 near the lower pot body 20, and the curved portions 211a form a second expansion zone 211b between the local protrusion 211 and the inner wall of the upper pot body 10. The role of the second expansion zone 211b is also to prevent the possibility of inability to maintain close contact between the annular body 100 and the inner wall of the upper pot body 10 under the impact of steam. By using the second expansion zone 211b, the space for steam to flow upward can be expanded, thereby reducing the impact of steam on the annular body 100.

In some other embodiments of the present disclosure, referring to FIG. 8, the curved portions 211a have a triangular cross-section. Preferably, the curved portions 211a have an acute triangle cross-section. In these embodiments, the space of the second expansion zone 211b is larger, which can receive more steam flowing upward. At this time, the contact area between the local protrusion 211 and the inner wall of the upper pot body 10 is larger. Therefore, the stability of the close contact between the local protrusion 211 and the inner wall of the upper pot body 10 is better. However, at the same time, the user also needs to shake the upper pot body 10 forcefully to throw the annular body 100 out of the upper pot body 10.

In some other embodiments of the present disclosure, referring to FIG. 9, the curved portions 211a have a curved cross-section. Preferably, the curved portions 211a have an inferior curved cross-section. In these embodiments, the space of the second expansion zone 211b is relatively small, and the space that can receive steam flowing upward is also low. However, in these embodiments, the contact area between the local protrusion 211 and the inner wall of the upper pot body 10 is smaller. Therefore, while ensuring the stability of the close contact between the local protrusion 211 and the inner wall of the upper pot body 10, the user does not need to shake the upper pot body 10 too hard to throw the annular body out of it.

Further referring to FIG. 5, FIG. 8 and FIG. 9, an extension 121 is arranged along the inner annular wall 120 of the annular body 100 towards the lower pot body 20. When the filter mesh 200 is supported inside the annular body 100, the extension 121 can increase the contact area between the outer wall of the filter mesh 200 and the inner annular wall 120 of the annular body 100, thereby enhancing the stability of the assembly between the annular body 100 and the filter mesh 200.

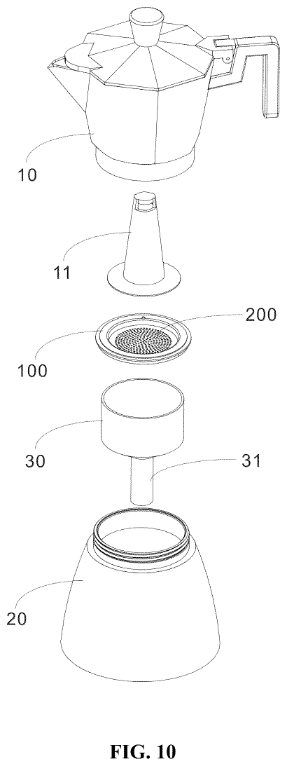

In some other embodiments of the present disclosure, a moka coffee pot is provided. Referring to FIG. 10, by adding the gasket structure described above, the gasket and the filter mesh 200 can be more easily removed. Moreover, the moka coffee pot further includes a powder trough 30. The powder trough 30 is placed inside the lower pot body 20 to place coffee powder. When the filter mesh 200 and the annular body 100 are placed above the lower pot body 20, the filter mesh 200 covers on the powder trough 30. A siphon 31 is provided at a bottom of the powder trough 30 to communicate with the lower pot body 20. When the lower pot body 20 is heated, its steam pressure pushes the water inside the lower pot body 20 into the powder trough 30 through the siphon 31, gradually dissolving the coffee powder in the bottom of the powder trough 30. An outlet pipe 11 is provided in a middle of the upper pot body 10 to cover on the annular body 100 and a top of the filter mesh 200, and the dissolved coffee powder forms coffee liquid that passes through the filter mesh 200 and continues to advance upwards, finally flowing out of the outlet pipe 11 into the upper pot body 10.

The details of the exemplary embodiments described above can be implemented in other specific forms without departing from the concept or essential features of the present disclosure. Therefore, from any point of view, the embodiments of the present disclosure should be regarded as exemplary and non-limiting, and the scope of protection of the present disclosure is limited by the appended claims rather than the above description. Therefore, it is intended to encompass all variations falling within the meaning and scope of equivalent features of the claims within the scope of the present invention.

What is claimed is:

1. A gasket structure, comprising an upper pot body, a lower pot body, and an annular body;
wherein the annular body comprises an outer annular wall, an inner annular wall, and an end surface arranged between the outer annular wall and the inner annular wall;
wherein a filter mesh having a sheet structure is arranged at a center of the annular body, an outer wall of the filter mesh is closely attached to the inner annular wall of annular body, and the filter mesh has an annular end facing outward; and
wherein when the filter mesh is placed inside the annular body and the annular end is supported on the end surface, a local protrusion is formed by protruding outward along the outer annular wall of the annular body, and the local protrusion is in close contact with an inner wall of the upper pot body.

2. The gasket structure according to claim 1, wherein a non-contact part is provided on the outer annular wall of the annular body, and the non-contact part is not in contact with the inner wall of the upper pot body when the local protrusion is in close contact with the inner wall of the upper pot body; and
wherein the non-contact part is obliquely offset along the outer annular wall of the annular body towards the center of the annular body to form a first expansion zone with the inner wall of the upper pot body.

3. The gasket structure according to claim 2, wherein a cross-sectional area of the local protrusion accounts for less than one-third of a cross-sectional area of the outer annular wall of the annular body.

4. The gasket structure according to claim 3, wherein several curved portions are provided on a side of the local protrusion near the lower pot body, and the curved portions form a second expansion zone between the local protrusion and the inner wall of the upper pot body.

5. The gasket structure according to claim 4, wherein the curved portions have a triangular cross-section.

6. The gasket structure according to claim 4, wherein the curved portions have a curved cross-section.

7. The gasket structure according to claim 1, wherein an extension is arranged along the inner annular wall of the annular body towards the lower pot body.

8. A moka coffee pot, comprising the gasket structure according to claim 1.

9. The moka coffee pot according to claim 8, wherein further comprises a powder trough, the powder trough is placed inside the lower pot body, the filter mesh covers on the powder trough, a siphon is provided at a bottom of the powder trough to communicate with the lower pot body, and an outlet pipe is provided in a middle of the upper pot body to cover on the annular body and a top of the filter mesh.
